(19) United States
(12) Patent Application Publication
(10) Pub. No.: US 2002/0045452 A1
(43) Pub. Date: Apr. 18, 2002

(54) Method and apparatus for accepting and conveying a message from a telephone to a radio-paging system

(76) Inventor: Terence E. Sumner, Rowlett, TX (US)

Correspondence Address: JENKENS & GILCHRIST, PC, 1445 ROSS AVENUE, SUITE 3200, DALLAS, TX, 75202, US

(21) Appl. No.: 09/774,086

(22) Filed: Jan. 27, 2001

Related U.S. Application Data
(63) Continuation of application No. PCT/US00/16687, filed on Jun. 15, 2000.
(60) Provisional application No. 60/140,184, filed on Jun. 16, 1999.

(51) Int. Cl. H04Q 7/20

(52) U.S. Cl. 455/445; 455/458

(57) ABSTRACT

A novel alpha-like member (“alpha 2”) of the human glycoprotein hormone family and nucleic acid molecules encoding it have been discovered. Vectors, host cells, and methods for producing this alpha 2 polypeptide are disclosed. Also described are methods for the use of alpha 2, including methods for the production of antibodies and for the diagnosis and treatment of disorders associated with alpha 2.

### BACKGROUND OF THE INVENTION

1. Field of the Invention

This invention relates generally to broadcast messaging systems, and more specifically to a method and apparatus for accepting a message through a telephone and transporting the message to a broadcast messaging system, such as a radio-paging system.

2. Description of Related Art

Modern radio-paging systems, sometimes referred to as broadcast messaging systems, can convey a message to one or to a plurality of subscriber devices through known broadcast techniques. Broadcast paging messages have typically been used for delivery of telephone numbers, text messages, and other short-message data. Typically, such systems operate by having a subscriber give an access number to potential callers. This access number is usually a telephone number, or a telephone number plus a personal identification number (PIN). Such radio-paging systems are generally connected to a telephone system at the telephone number specified. When a caller dials the access number, the call is connected to a radio-paging terminal that picks up the call. The radio-paging terminal prompts the caller to enter a telephone number to be displayed on the subscriber's device. The radio-paging terminal then waits for the caller to enter normal telephone dialing digits. The radio-paging terminal may prompt the caller for the PIN prior to this. The radio-paging terminal then signals the caller that the dialed digits are accepted. The terminal typically translates the PIN or the telephone number into a device address on a predetermined radio channel and delivers a message with the dialed digits to a subscriber device or devices through known radio-paging messaging techniques. A radio paging device may alternatively accept a voice message, record it and deliver a message to the subscriber device along with information about the recorded voice message. Furthermore, when a radio paging terminal picks up a call, it may optionally play a brief message (possibly prerecorded by the subscriber) to aid in confirming the identity of the subscriber or other pertinent information.

Since many subscribers can be accessed over a single radio channel, radio-paging has proven to be a highly efficient tool for conveying numeric information to subscribers through broadcast transmission.

A limitation of prior radio-paging systems has been the need for large numbers of incoming lines at the radio-paging terminal and the consequent cost. That is, each subscriber must have a telephone number and the associated public switched telephone system must terminate the call to that number on the paging terminal. This can entail a large number of trunk lines in accordance with the number of subscribers and their associated traffic. The use of PINs with a single access number does not materially reduce the number of incoming trunk lines to the paging terminal, unless multiple calling areas are covered. However, in the case wherein the paging terminal is located within the local calling area of the caller, no transport cost or toll charges apply. In the case that the paging terminal is located outside the local calling area or if the call is delivered to the paging terminal over inter-exchange (IXC) lines, additional transport costs may be incurred.

Furthermore, the size and cost of a radio-paging terminal must be considered. Small paging terminals can be geographically placed so that a paging terminal is placed in each of the various calling areas. This technique works reasonably well for relatively small systems, but is less cost-effective because it requires more terminals and does not provide centralized efficiencies for site and equipment maintenance costs.

A large radio-paging terminal can be cost efficient for handling a large volume of calls, but as discussed above, requires a large number of trunk lines from various local calling areas onto long-haul trunk lines. This arrangement is advantageous if the local calling areas are geographically located at widely separated regions that have different peak-traffic times that do not significantly overlap. Furthermore, this type of arrangement has operated reasonably well for various large paging networks, especially in areas where radio coverage is much larger than individual calling areas. This arrangement does not work as well as small radio-paging terminal systems for keeping the transport costs low.

In modern telephone switching systems, such as those based on Signaling System #7 (SS7), a separate control path, in addition to the voice-connection, for the caller to dial on is utilized. This additional, separate path is for telephone control signals, such as ISDN user part (ISUP) or transaction capabilities application part (TCAP) protocol control signals from the local exchange to the call destination. These signals presently provide information about the call origin and destination and supply in limited cases, supplementary information such as calling card or credit card numbers.

Thus, what is needed is a method and apparatus for radio-paging that provides the low cost of transport of a distributed small-terminal system while achieving a high degree of efficiency and cost-effectiveness of large-terminal operation. Further, what is needed is a method and apparatus that will retain the high efficiency characteristics of prior art broadcast messaging techniques, while raising, by a significant degree, the convenience in maintenance and further lowering the number of radio-paging terminal sites required.

### SUMMARY OF THE INVENTION

An aspect of the present invention is a method in a broadcast messaging system for collecting dialed digits at the local telephone exchange and utilizing existing facilities without requiring transport connection. The method comprises the step of pre-programming a database at the local exchange that controls the disposition of calls, the database specifying that for calls to numeric paging subscriber numbers that the call is handled as specified by a second remote database to complete the call. The method further comprises the steps of launching an inquiry from a local exchange over a separate control path to the remote database to retrieve instructions from the remote database; and sending a control message from the remote database containing the retrieved instructions, including that the local exchange is to signal the caller to enter more digits and is to deliver said collected digits over the separate control path in a control message to the remote database for interpretation. The method may further comprise the step by the remote database of interpreting the delivered control message and sending instructions to the local exchange to signal the caller that the information is complete and ultimately to signal the local exchange to disconnect the call.

Another aspect of the present invention is a method in a broadcast messaging system for collecting dialed digits at the local telephone exchange, utilizing existing facilities, requiring only minimal transport connection. The method comprises the step of pre-programming a database at a local exchange that controls the disposition of calls. The database specifies that calls to paging subscriber numbers will be handled as specified by a remote database to complete the call. The method further comprises the steps of launching an inquiry from a local exchange over a separate control path (such as an SS7 network) to the remote database; the local exchange then retrieves instructions from the remote database; and then the remote database sends a control message from the containing the retrieved instructions. The message may include an instruction to the local exchange to connect the caller temporarily to an announcement device (not specifically shown) over a transport path and then the local exchange is to signal the caller to enter more digits and then deliver a control message containing the entered digits over the separate control path to the remote database for interpretation. The method may flier comprise the step, by the remote database, of interpreting the control message and then sending instructions to the local exchange to signal the caller that the information is complete and then ultimately to signal the local exchange to disconnect the call.

Another aspect of the present invention may include a remote database server. The exemplary remote database server comprises a control interface for receiving a message from a local exchange. The remote database server further comprises a processing system coupled to the control interface for processing the message. The processing may comprise determining, from the message, the subscriber being called; determining relevant information about the caller; retrieving subscriber record information; and formulating an instruction-message to the local exchange through the control interface. Instructions could also include collecting dialed digits from the caller to identify the caller and services requested, collecting dialed digits from the caller specifying a message to the subscriber, playing various tones to the caller to reflect the status of call progress, optionally connecting the call temporarily to an announcement unit over a transport path, alternatively connecting the call temporarily to a paging terminal, and disconnecting the call. The messaging interface is coupled to the processing system for communicating with a messaging terminal processed call information and the collected message from a caller.

A further aspect of the present invention is a method in a broadcast messaging system for collecting dialed digits at the local telephone exchange, utilizing existing facilities and requiring only a minimal transport path connection. The method may comprise the step of pre-programming a database, at the local exchange that controls the disposition of calls, to specify that for calls to paging subscriber numbers that the call be handled as specified by a remote database to complete the call. The method may further comprise the steps of launching an inquiry from the local exchange over a separate control path (e.g. SS7) to the remote database to retrieve instructions from the remote database; sending a control message from the remote database to the local exchange. The sent/retrieved message containing, among other things, instructions that the local exchange is to connect the caller temporarily to an announcement device over a transport path, wherein the announcement is tailored specifically to the call; then the local exchange is to signal the caller to enter more digits and is further to deliver a control message to the remote database containing the entered digits to the remote database for interpretation. The announcement may be tailored by at least one of the following: identification of the subscriber, identification of the caller, location of the caller, a calendar or clock reflecting tailoring parameters determined by the subscriber, or current volume of traffic in queue, or disposition of messages by the subscriber. The method may further comprise the step, by the remote database, of interpreting the delivered control message and then sending instructions to the local exchange to signal the caller that the information is complete and then to signal the local exchange to disconnect the call.

### BRIEF DESCRIPTION OF THE DRAWINGS

FIG. 1 is an exemplary block diagram of a radio-paging broadcast messaging system in accordance with an embodiment of the present invention.

FIG. 2 is an exemplary block diagram of a remote database in accordance with an embodiment of the present invention.

FIG. 3 is an exemplary system flow chart of a radio-paging messaging system in accordance with an embodiment of the present invention.

### DETAILED DESCRIPTION OF THE PREFERRED EXEMPLARY EMBODIMENTS

Referring to FIG. 1, an exemplary block diagram of a radio-paging broadcast messaging system 10 in accordance with the present invention is depicted. Telephone callers 5 dial into the local exchange switch (CO) 12. The local exchange switch 12, using control path 6, looks up the dialed number in its local database (DS) 14, typically through an adjunct computer 18, to determine the ultimate service control point (SCP) 16 controlling the number or the correct switch if the number is ported. The adjunct computer 18 usually serves as the service switching point (SSP) for the control network 6, having its own control path into the network 6. The signal transfer point (STP) 20 connects SSPs through other STPs (not specifically shown) to a service control point (SCP) 16, where a remote subscriber database is stored. The remote subscriber database servicer SCP 16 is connected to the control network using at least one of Telephone User Part (TUP), ISDN User Part (ISUP), Transaction Capabilities Application Part (TCAP), all supported to varying degrees by the public SS7 network. Transport is provided through tandem switches or aggregation points that groom large numbers of voice circuits, typically T1 or T3 for connection to a large termination point, such as the paging system terminal 22. The paging system 10 accepts calls, converts subscriber information, i.e. dialed numbers or PINs, to device addresses, typically referred to as capcodes, and passes the message along through the radio channel controller 24 to be transmitted via transmitter 26 to subscriber device 28 on a particular frequency in accordance with the air protocol.

The remote database SCP 16 is also connected to the paging system terminal 22, providing a path for collected dialed numbers to subscribers to be submitted into the paging system terminal 22. The exemplary paging system terminal 22 allow messages from an SCP 16 to be submitted using at least one of: Telelocator Network Paging Protocol (TNPP), Terminal Message Entry (TME), Wireless Messaging application programming interface (WMapi), electronic mail (SMTP), or Wireless Communication Transport Protocol (WCTP). It is noted that in prior art paging systems the SCP 16 was not connected to the paging system terminal and possibly a terminating SSP 19 was utilized to complete the control path 6.

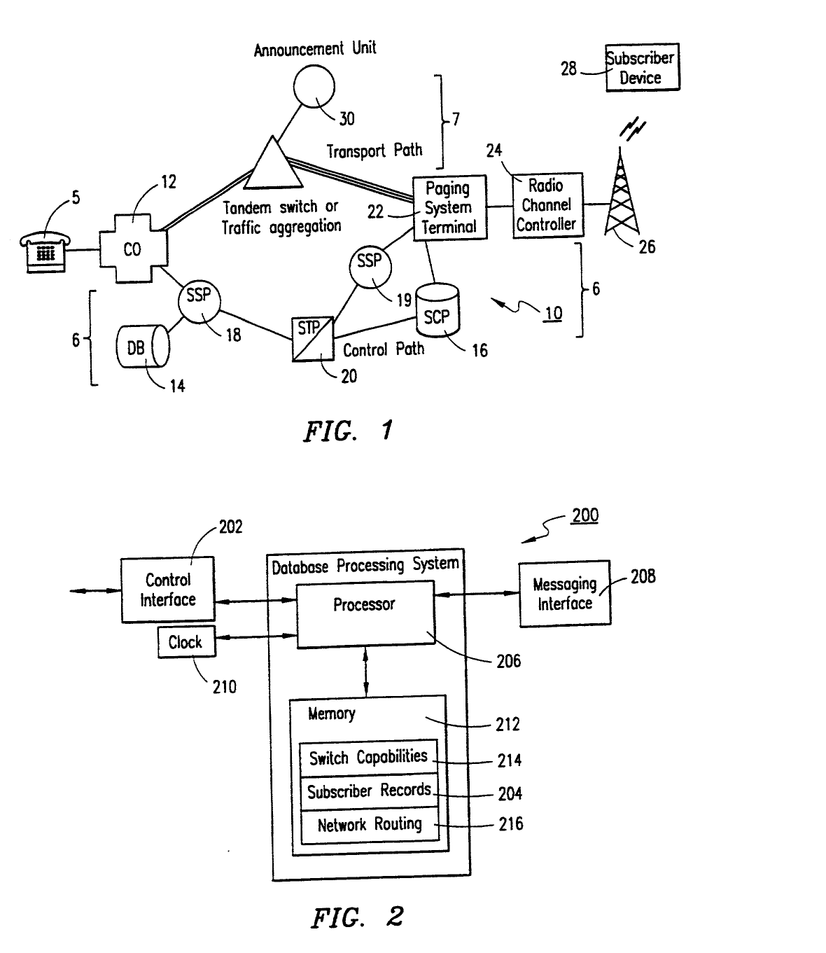

Referring to FIG. 2, a block diagram of an exemplary remote database 200 within an SCP 16 in accordance with an embodiment of the present invention is shown. Control messages are received and sent through a control path interface 202. The originating point code is used to determine the capabilities of the exchange at the associated SSP 18 to handle the call. The dialed number contained in the message is used to look up the subscribers record in the subscriber records 204 portion of memory. Based on the capabilities of the originating exchange, the topology of the transport path 7 and the subscriber's record, an instruction sequence is formulated by the remote database processing system (200, 16) for the instant call and an associated control message is returned out of the control interface 202 through the control path 6 to the origination SSP 18 and associated exchange 12. It is understood that the transport path is for audio signals. Furthermore, switches such as SSPs may not be capable of TCAP features (producing standardized digital audio sounds such as tones in the control path) therefore, predetermined audio sounds can be provided to the caller via the transport path, if necessary.

The switch capabilities 214 portion of the memory 212 stores the capabilities of the local SSP 18 so that the SCP 16 can determine whether the local switch has the capability to provide paging capabilities via the control path 6 as provided in the exemplary embodiments discussed herein. Furthermore, the network routing 216 portion of memory 212 stores information for, among other things, determining where on the overall network 10 announcement units, voice mailboxes, paging system terminals, etc., can be found.

The processor 206 supports the protocols used by the control and messaging interfaces 202, 208 and is synchronized to the connected networks by a clock 210. Formulation of instruction sequences is computed in the processor 206, either by pre-computing and storing the result in the memory 212 or, preferably, by computer at the time of the call. An instruction sequence may be a single message in response to the originating exchange 12, but usually several instruction sequences are needed to control any multiple step responses. Network topology is used to balance loads for various types of similar devices and to take account of added or out-of-service equipment and links. In a large network several paging terminals may be available, several announcement units, several interactive voice response units, and many paths to connect to these devices. The balancing of loads and accounting for equipment availability can consume considerable processor computation time. Subscriber-determined calendar and caller profiles for a subscriber, stored in the remote database, can be used to alter the normal sequence of instructions. At night, the subscriber may wish his callers to receive a message that their message will be stored until morning. Certain callers may be blocked at the request of the subscriber. Certain originating locations of callers may be given preferential treatment or even be prevented from accessing the subscriber owing to toll charges. Anonymous calls may be blocked. Blocked callers may be given the option of leaving voice-mail, or paying their refused toll charges by credit card, or identifying themselves satisfactorily to the remote database. Such identification for access might be through a passcode given to the caller by the subscriber. During heavy calling periods the subscriber may wish to categorize some callers as lower priority and have a call treated as if it were after hours.

Protocol support on the control interface is preferably TCAP. TCAP provides the mechanism to reduce the transport required to support paging. Protocol support on the messaging interface is preferably TNPP. TNPP is more universally available, although additional features can be activated in WCTP, WMapi and TME with extensions.

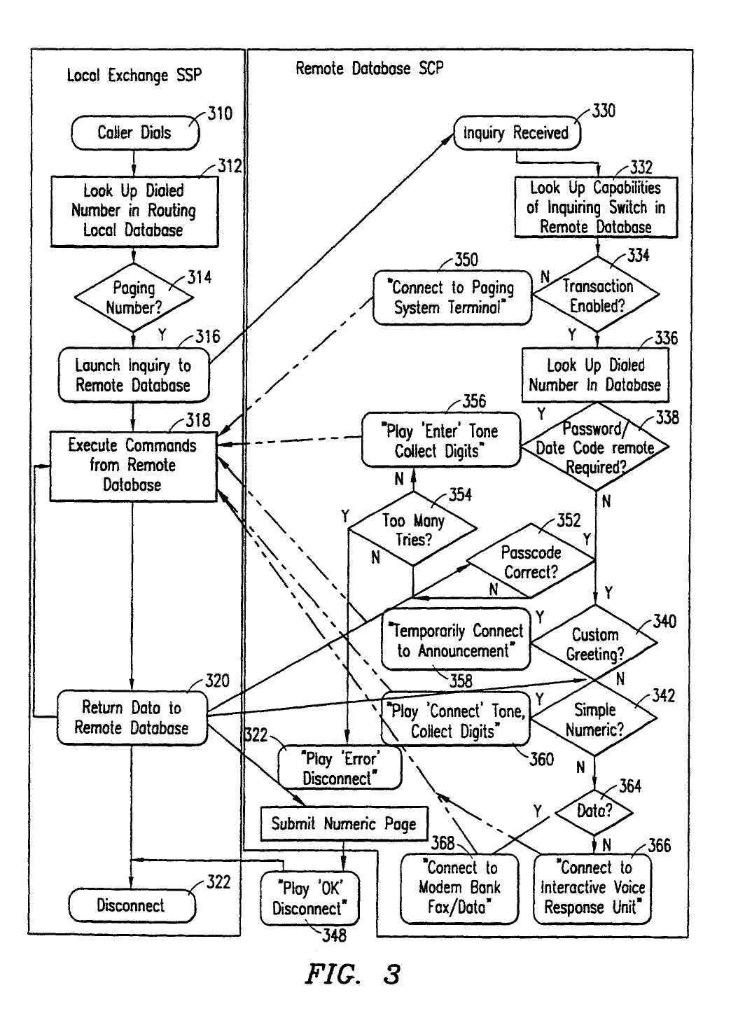

Referring to FIG. 3, an exemplary system flow chart of a radio-paging messaging system in accordance with the present invention is depicted. One of ordinary skill in the art could understand the pictorially described system. At step 310 a person or system may want to send a page to a subscriber's device 28. The person picks up phone 5 that is associated or connected to a local exchange/CO and dials the number of a pager/subscriber device 28. At step 312 the SSP 18 associated with the local exchange 12 looks up the number that the caller dialed in the SSP's local routing database 14 in order to determine where the call is to be routed and via what switches. The SSP will find a point code. If this were a normal call (not a paging call) the point code would be for a remote SSP 19 so that the call will be controlled by the remote SSP. But, if the local database 14 and exchange 12 or SSP 18 determines, in step 314, that the exemplary call is for a paging number then the point code in the local database 14 will direct the call to a remote SCP 16 via the service control point code. In other words, SSP 18 will, via a SS7 point code discovered in step 314, direct the remote SCP 16 to control the paging call.

At step 316 the SSP 18 launches or sends an inquiry to the SCP 16 the requests instruction on how to handle the page call. The SSP 18 sends a control message over, for example the SS7 control path 6.

In step 330 the SCP 16 receives the inquiry from the SSP. In step 332 the SCP looks into its database memory and determines the switching capabilities of the originating SSP 18 switch. If the SSP switch can handle the page call substantially over the control path 6 (instead of the transport/audio path 7) then the transaction will be considered enabled in step 334.

On the other hand, if the SSP 18 switch cannot handle the page call substantially over the control path, then at step 350 a message is sent back from the SCP 16 to the SSP 18 indicating that the page call should be handled using only the transport path 7. Thus, in step 350 a command will be returned to the SSP at step 318 instructing the SSP at the local exchange to connect the call in the normal (prior art) traditional paging fashion via the transport path to the paging system terminal.

Assuming the transaction was enabled at 334 due to the remote database indicating that the local SSP can handle the exemplary page call via the control path then, at step 336 the remote SCP looks up the dialed number in its remote database. The SCP must determine how to handle the exemplary page call for the particular number. There are, at this point, various possible alternatives. For example, whether the this subscriber's page requires a password; whether a custom greeting to the caller is required; or whether there is a provision for handling data, fax or data transfers.

Assuming for the moment that there is not a password required (step 338), no custom greeting (step 340) and that this is a “simple numeric” number using a telephone dial/keypad on which is to be delivered to subscriber device 28, then at step 342 it is determined that this call be sent to a numeric style paging device. At step 360 a command is sent back to the local SSP 18 that tells the SSP to play a connect tone to the caller and to collect numeric digits entered by the user at step 318.

Once the numeric digits are collected, at step 320 the numeric digits are sent to the SCP 16 for processing. The numeric digits (and possibly other data) are passed across the control path/SS7 network to the SCP. At step 346, the numeric digits associated with the exemplary page call are submitted to indicate what numeric message will be provided at/displayed on the paper/subscriber device 28. The SCP processes the numeric message for display, provides them to the paging system terminal 22 via preferably a TNPP or similar connection (e.g. TME or SMTP) between the SCP and the paging system terminal. This is done because in prior paging systems an SCP is not directly connected to a paging system terminal.

In step 346, the SCP will send a command back to the SSP (not specifically shown) to step 318 to indicate that the numeric message was accepted. The SSP 18, as a result, will play an “OK” disconnect at step 348 to the caller to indicate that the page call was accepted. At step 322 the exemplary call is disconnected. Note that the transport path 7 (the voice path/circuit connection) was not needed to complete the page call.

In situations when the transport path is not connected for call, then the user is not charged. Thus, the exemplary embodiment may need to provide a signal to the exchange 12 to indicate that the call was complete even though the transport path was not utilized.

The FIG. 3 flow chart indicated that there are other possible and/or additional options that can be associated with a page call. For example, at step 338 a password or passcode may be required. If there is a requirement indicated in the SCP remote database that a password or passcode is required, then at step 356 a command is sent from the SCP to the SSP to request the caller to enter the necessary password or passcode.

At step 318, the SSP executes the command to the caller, collects the password or passcode and goes to step 320 wherein the collected password or passcode is delivered to the SCP over the control path 6. At steps 352 and 354 it is determined whether the passcode is correct and whether additional tries, by the caller, to enter a correct password or passcode should be allowed. If no more tries to enter the password/passcode are allowed, then at step 362 an error code is played and the call is disconnected.

If the password/passcode is correct then at step 352 the exemplary page call continues on.

At step 340 the SCP determines if its remote database indicates that there is a custom greeting required. A custom greeting may be the voice of the party who is being paged stating, “Hello, you have called Mr. Smith's (for example) page number, please enter the appropriate numeric page at the tone.” If a custom greeting is required in step 340, then at step 358 a command is sent from the SCP to the SSP, via the control path in step 318 and 320 to temporarily connect to the voice transport path 7 and to an announcement unit 30 to play the greeting to the caller. Once the announcement is played to the caller the voice transport path is disconnected. Thus, the voice transport path connection for a greeting is very short (e.g. about 3 to 10 seconds) and then disconnected. The transport path is used for as short a period as absolutely essential to get an audio sound, such as a prompt or voice greeting played. The transport path is used momentarily rather than the typical average of twenty five seconds required by a traditional paging call having an audio greeting and that only utilizes the transport path. Once the greeting has been played the method moves to step 342 which has been described above.

At step 342, if the page communication is determined to be set up for a data transfer such as a fax or modem data transfer. At step 368 the remote SCP sends a command to the local exchange SSP step 318 to execute the data transfer. The data transfer could be sent either over the control path or the transport path. Most likely the data transfer will be connected and transferred from the caller to the paging system terminal or data modem point via the transport path due to the expense of tying up the SS7 control path network for an extended period of time. Once the data transfer is complete the exemplary call can be disconnected.

If a data transfer was not requested, needed, or to be set up at step 364, then the caller may be connected to an interactive voice unit in accordance with step 366. The remote SCP will instruct the local exchange at step 318 to connect the call to an appropriate interactive voice unit via the transport path.

Referring back to FIG. 1, an important aspect of the exemplary system and method is related to the remote SCP 16 being in substantially direct communication with the paging system terminal 22. A network similar in nature to the SS7 network might be used in communication from the SCP 16 to one or more paging terminals 22 (although a direct connection is expected). The exemplary communication path between the remote SCP 16 and the paging system terminal helps enable an exemplary paging system and method that does not require a connection to a transport path. An entire numeric page call can be performed by utilizing only the control path (SS7) of communication. A SS7 control path can allow TCAP transaction capability, such as collecting numeric information via caller input on a standard phone keypad or by using caller ID technology. Unlike an SSP, an SCP can identify not only the calling number, but also is capable of obtaining supplementary data for example, calling card, or additional dialed digit information from the caller. Thus, a transport connection and associated SSP connection to a paging system terminal is not needed to implement many exemplary embodiments of the present invention if an SCP connection exists to a paging system terminal. It is understood that in some exemplary embodiments of the present invention such a connection between an SCP and a paging system terminal will greatly reduce the need for a transport path connection and/or an SSP connection to a paging system terminal.

It will further be appreciated that while the system method and apparatus described could also be used for providing services other than messages for paging subscribers, the particular characteristics of paging are well matched to the invention and typical existing telephone techniques can fulfill the required characteristics for delivering ordinary voice calls.

Thus, it should be clear from the preceding disclosure that the present invention provides a method and apparatus for accepting and conveying a message from a telephone to a radio-paging system. Advantageously, the method and apparatus retains the low transport cost of distributed small-terminal systems and the high degree of cost-effectiveness and efficiency of large-terminal operation, while raising by a significant degree the convenience in maintenance and lowering the number of sites required.

Although various preferred embodiments of the invention have been shown and described, it will be appreciated by those skilled in the art that changes may be made to these embodiments without departing from the principles and the spirit of the invention, the scope of which is defined in the appended claims:

What is claimed is:

1. A communication system utilized for paging comprising:
a local exchange where a paging call can be received from a caller;
a transport path for transporting audio transmissions from and to said caller;
a control path for communicating all data related to a paging call originated by said caller; and
a paging system terminal connected to said transport path and to said control path, said paging system terminal receives data related to said paging call from said control path and provides a paging message to a radio controller for transmission to a subscriber device.

2. The communication system of claim 1, wherein said control path comprises a service control point (SCP) connected substantially directly to said paging system terminal, said SCP comprising a remote data base comprising information about how to handle page subscriber calls; and
a service switching point (SSP) connected between said local exchange and said SCP, said SCP providing instructions to said SSP and to said local exchange regarding how to handle said paging call, said SCP further providing instructions to said paging system terminal providing data related to the creation of said paging message.

3. The communication system of claim 2, wherein said information about how to handle page subscriber calls is stored in a subscriber records portion of said remote database.

4. The communication system of claim 2, wherein said transport path is used substantially only to provide a custom greeting to said caller after being instructed to do so by said SCP.

5. The communication system of claim 1, wherein said transport path is used for fax data provided by said caller via said paging call after being instructed to do so by said SCP.

6. The communication system of claim 2, wherein said SSP determines if a caller originated call is a paging call and if said caller originated call is a paging call then said SSP communicates with said SCP over said control path to obtain instructions on how to handle said paging call.

7. The communication system of claim 1, wherein said control path utilizes SS7 protocol.

8. The communication system of claim 2, wherein said SCP requests said local exchange to provide a signal to said caller to provide numeric data, said numeric data being provided to said SCP via said control path.

9. The communication system of claim 8, wherein said numeric data is provided to said paging system terminal by said SCP.

10. The communication system of claim 2, wherein said SCP communicates to said paging system terminal via a TME protocol.

11. In a telephone to radio-paging broadcast messaging system a method for handling a paging call originated by a caller over a control path of said telephone to radio-paging broadcast messaging system, said method comprising the steps of:
pre-programming a local exchange SSP's data base with a point code directing a predetermined paging subscriber number to an SCP;
sending a TCAP message to said SCP when said predetermined paging subscriber number is dialed by a caller;
receiving said TCAP message at said SCP and determining an appropriate response to said to said TCAP message based on at least the capabilities of said local exchange SSP;
sending, by said SCP, at least one instruction to said SSP, said at least one instruction requiring said SSP to collect numeric data from said caller;
providing said numeric data to said SCP;
sending said numeric data from said SCP to a paging system terminal.

12. The method of claim 11, wherein said at least one instruction further requires said local exchange to temporarily connect to an announcement unit via a transport path.

13. A remote database for handling paging calls via a control path of a telecommunication system, said remote database comprising:
a control interface coupled to said control path of telecommunication system;
a processing system coupled to said control interface;
a messaging interface coupled to a paging system terminal for a broadcast messaging network.

14. The remote database of claim 13, wherein said control path communicates via SS7 protocol.

15. The remote database of claim 13 wherein said massaging interface is coupled to said paging system terminal via a non-SS7 interface.
